(19) United States
(12) Patent Application Publication
(10) Pub. No.: US 2015/0264896 A1
(43) Pub. Date: Sep. 24, 2015

(54) BEEHIVE INSULATING COVER

(71) Applicant: Benjamin Willingham PEEPLES, Johnson City, TN (US)

(72) Inventor: Benjamin Willingham PEEPLES, Johnson City, TN (US)

(21) Appl. No.: 14/664,574

(22) Filed: Mar. 20, 2015

Related U.S. Application Data
(60) Provisional application No. 61/968,194, filed on Mar. 20, 2014.

(51) Int. Cl. A01K 47/06; H05B 3/36

(52) U.S. Cl. CPC A01K 47/06; H05B 3/36

(57) ABSTRACT

A beehive cover is provided. The beehive cover includes at least one heating pad. The heating pad includes an outer insulating layer and an inner insulating layer. At least one heating cable is disposed in between the outer insulating layer and an inner insulating layer and the layers are sealed together. Electrical wiring connects the heating cables to a power source. A waterproof cover covers the heat pad. The beehive cover is then secured to the outer sides of a beehive in order to keep the beehive warm.

### CROSS-REFERENCE TO RELATED APPLICATION

This application claims the benefit of priority of U.S. provisional application No. 61/968,194, filed Mar. 20, 2014, the contents of which are herein incorporated by reference.

### BACKGROUND OF THE INVENTION

The present invention relates to beehives and, more particularly, to a beehive insulating cover.

A beehive is an enclosed structure in which some honey bee species live and raise their young. Natural beehives are naturally occurring structures occupied by honeybee colonies, such as hollowed-out trees, while domesticated honeybees live in man-made beehives, often in an apiary. These man-made structures are typically referred to as “beehives.”

Modern honey beekeeping utilizes beehives that do not provide the insulating value of beehives found in the wild. Current hive covers only use passive heat. If the temperature drops drastically or if there is not enough radiant sunlight the hive could die by freezing. Honey bees must keep the innermost part of the hive at least 80 degrees. Covers may not be enough to keep these hives protected.

As can be seen, there is a need for an improved bee hive cover.

### SUMMARY OF THE INVENTION

In one aspect of the present invention, a method of warming a man made beehive comprises: providing a heating pad comprising: an outer insulating layer; an inner insulating layer; at least one heating cable disposed in between the outer insulating sheet and the inner insulating sheet; electric wiring connecting the at least one heating cable to a power source; wrapping the heating pad around an outer surface of the man made beehive so that the inner insulating layer is adjacent the outer surface; and powering the at least one heating cable via the power source.

In another aspect of the present invention, a beehive cover comprises: at least one heating pad comprising: an outer insulating layer; an inner insulating layer; at least one heating cable disposed in between the outer insulating sheet and the inner insulating sheet; electric wiring connecting the at least one heating cable to a power source; and a waterproof cover covering the at least one heating pad.

These and other features, aspects and advantages of the present invention will become better understood with reference to the following drawings, description and claims.

### BRIEF DESCRIPTION OF THE DRAWINGS

FIG. 1 is a perspective view of the present invention shown in use demonstrating overall component configuration and external electrical configuration;

FIG. 2 is a top view of an embodiment of the present invention demonstrating the component configuration around a beehive;

FIG. 3 is a detail view of the wiring and heat cables of an embodiment of the present invention;

FIG. 4 is an exploded view of the electrical heating pad incorporating the electrical component from FIG. 3;

FIG. 5 is a perspective view of part of the electrical heating panel with a cover omitted;

FIG. 6 is a perspective view of the electrical heating panel and the cover;

FIG. 7 is a rear view of the electrical heating panel with the cover showing rear hook and loop fasteners; and

FIG. 8 is an exploded view demonstrating operational components of the insulating pad.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include a DC powered heat tape system for heating Langstrom style beehives in cold weather. The DC powered exterior heat tape pads cover the outside surfaces of the beehive reducing wind-chill and providing minimal heating of the hive. Providing a heat source on the outside of the hive does not interfere with bee behavior during winter months and can help the bees maintain needed temperatures.

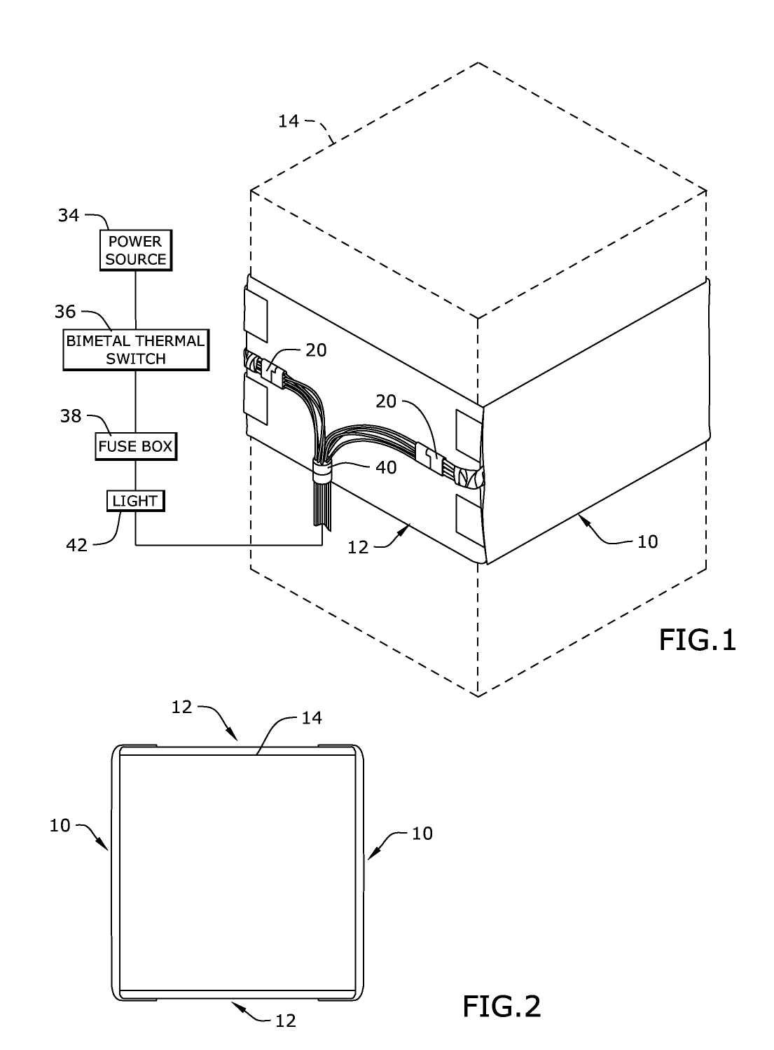

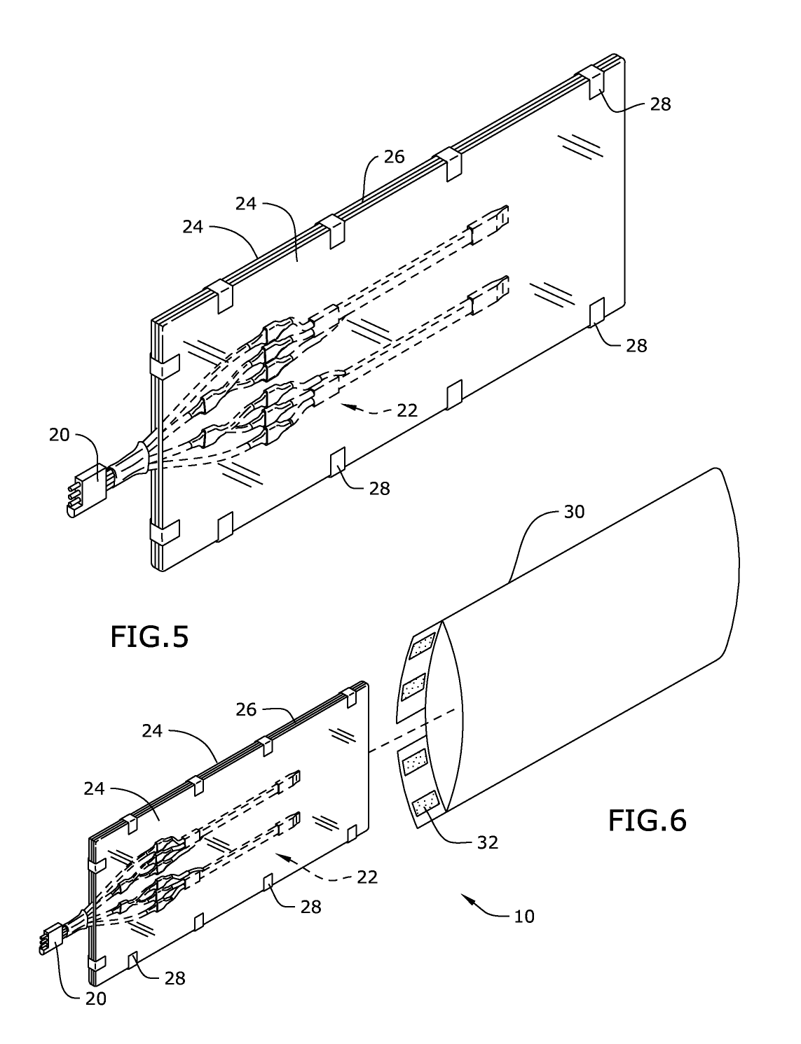

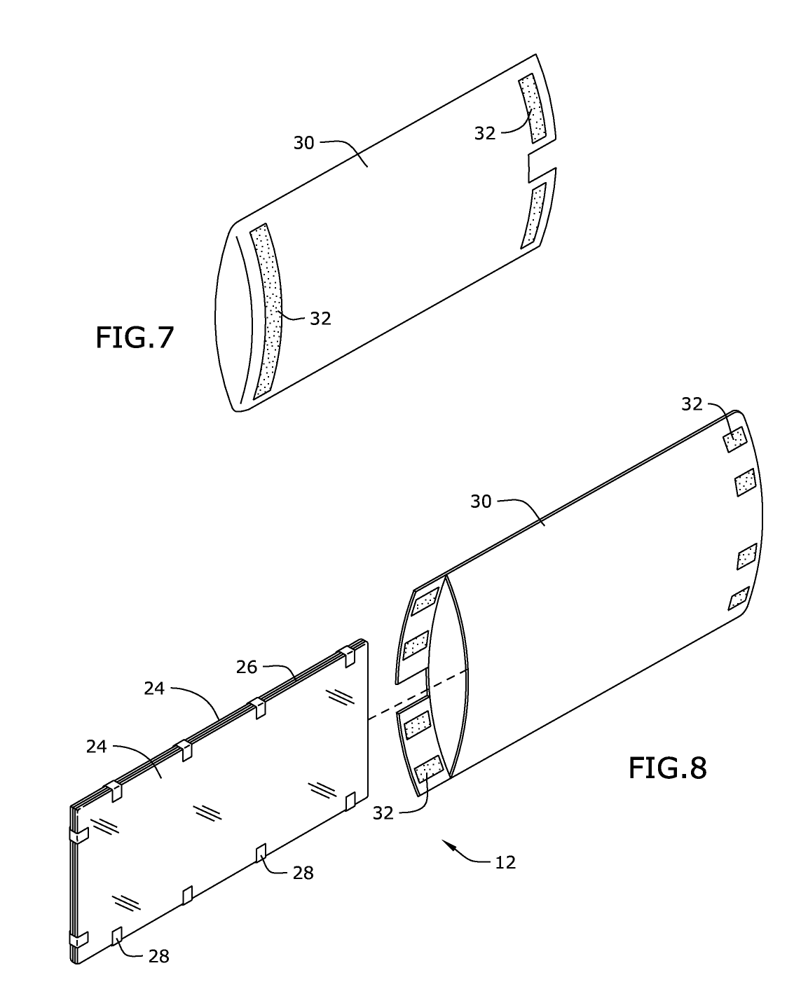

Referring to FIGS. 1 through 8, the present invention includes a beehive cover. The beehive cover includes at least one heating pad 10. The heating pad 10 includes an outer insulating layer 24, 26 and an inner insulating layer 24, 26. At least one heating cable 16 is disposed in between the outer insulating layer 24, 26 and an inner insulating layer 24, 26, and the layers 24, 26 are sealed together. The layers 24, 26 may be sealed together by tape 28, an adhesive, or any mechanical fastener. Electrical wiring 22 connects the heating cables 16 to a power source 34. A waterproof cover 30 covers the heat pad 10. The beehive cover is then secured to the outer sides of a beehive 14 in order to keep the beehive 14 warm.

In certain embodiments, the present invention includes a series of pads 10, 12. As illustrated in FIGS. 1 and 2, the present invention includes a pair of heating pads 10 and a pair of insulating pads 12. The insulating pads 12 may include the same layers 24, 26 of the heat pad 10 without the heated cables 16. A first insulating pad 12 covers a first side of the beehive 14, a first heating pad 10 covers a second side of the beehive 14, a second insulating pad 12 covers a third side of the beehive 14, and a second heating pad 12 covers a fourth side of the beehive 14. The first insulating pad 12 may be connected to the first heating pad 10, the first heating pad 10 may be connected to the second insulating pad 12, the second insulating pad 12 may be connected to the second heating pad 10, and the second heating pad 10 may be connected to the first heating pad 12. The insulating pads 12 and the heating pads 10 may be secured within the waterproof covers 30. The waterproof covers 30 may be secured to one another by hook and loop fasteners 32.

As mentioned above, each of the heating pads 10 includes an outer insulating layer 24, 26 and an inner insulating layer 24, 26. Each of the outer insulating layer 24, 26 and the inner insulating layer 24, 26 may include a polyester batting sheet 26 and a flexible foil sheet 24. The polyester batting sheets 26 may surround the heating cables 16 and the flexible foil sheets 24 may surround the polyester batting sheets 26. The waterproof cover 30 covers the entire heating pad 10 and may prevent the heating cables 16 and insulating layers 24, 26 from becoming wet. The waterproof cover 30 may be a canvas material or other waterproof material.

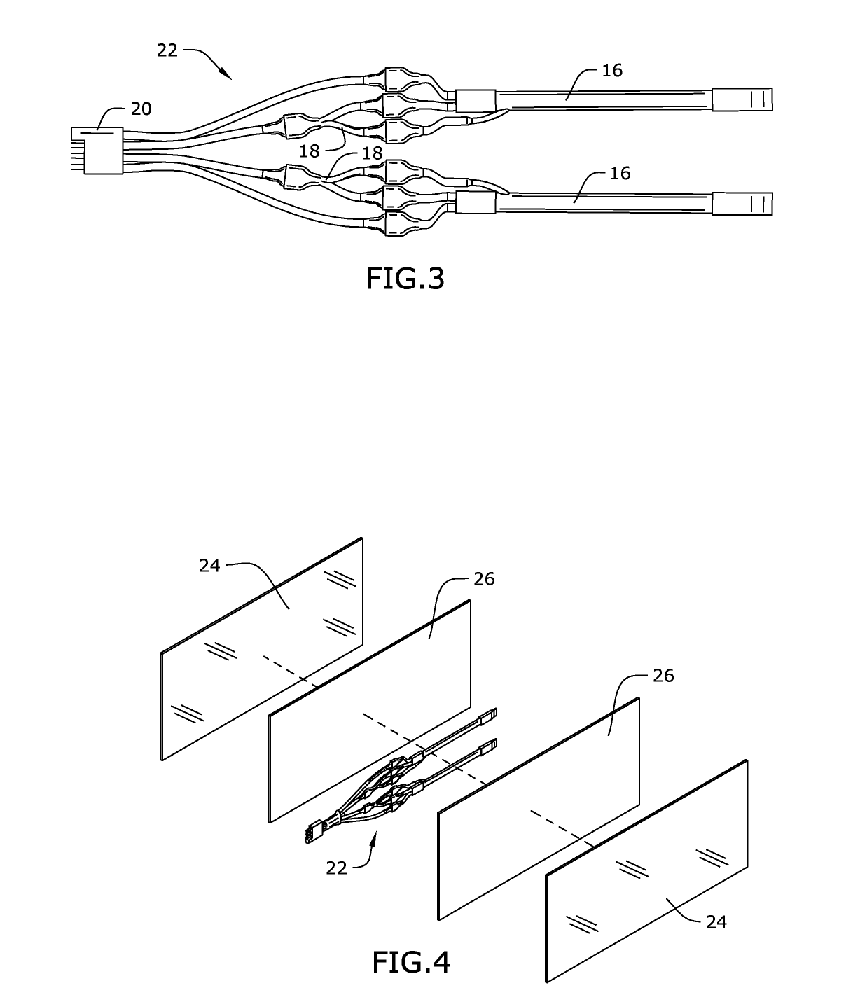

As illustrated in FIGS. 3, the present invention may include two heating cables 16 suspended in each heating pad 10. The two heating cables 16 are connected to wiring 22. The wiring 22 may include low voltage heating cable termination kits 18 that are connected to an auto/trailer connection 20. The auto/trailer connection 20 may be connected to a power source 34 via a 10-Male/Female connector 40. In certain embodiments, the present invention may utilize a fuse box 38 to prevent fires. A bimetal thermal switch 36 may be used to turn the heating cables 16 on and off when a certain temperature threshold is detected. A light 42 may be electrically connected to the power source 34. The light 42 is turned on when power is supplied to the at least one heating cable 16.

In an embodiment of the present invention, heat cables may terminate on one end with cable termination kits. The heat cable wire leads may be connected to male connectors resulting in two six inch heat cables. One side of a 12V hour wire auto/trailer connector may be connected to female connectors and then connected to male connectors that are attached to the heat cables. This electrical apparatus may be placed between two polyester battings which is then placed between two insulated panels using electrical tape to secure in place. Duct tape may be used to seal the panel. This process produces two 17.5 inch electrical panel inserts which are placed into a two canvas slip covers. Two polyester battings are placed between two insulated panels. Duct tape is used to seal the panel. This process produces two 14.5 inch non-electric insulating pads which are placed into two canvas slip covers. The alternating side of the 12V auto/trailer connector is fitted with a 12V bimetal thermal switch and a 10 amp fuse kit. The remaining wire leads from the 12V auto/trailer connector are fitted with connectors.

The pads fit the sides of a deep Langstrom hive type box providing passive thermal insulation against cold weather. They connect using Velcro® connections. When the electrical leads are connected to a 12V source the pads with internal heat tapes provide heating once the thermal switch is triggered. The switch is triggered when the outside temperature drops to about 40 degrees or lower. The thermal switch remains on until the outside temperature rises to about 50 degrees.

Weak beehives often succumb to weather when the bees are unable to stop the hive heating process long enough to eat. By providing a minimal heat source for honey beehives during cold weather, enough heat can be maintained to assist the bees with survival but not too much heat which can change bee behavior. The pads also provide a wind break and more insulation to the hive which helps in moderate cold periods.

It should be understood, of course, that the foregoing relates to exemplary embodiments of the invention and that modifications may be made without departing from the spirit and scope of the invention as set forth in the following claims.

What is claimed is:

1. A method of warming a man made beehive comprising:
providing a heating pad comprising:
an outer insulating layer;
an inner insulating layer;
at least one heating cable disposed in between the outer insulating sheet and the inner insulating sheet;
electric wiring connecting the at least one heating cable to a power source;
wrapping the heating pad around an outer surface of the man made beehive so that the inner insulating layer is adjacent the outer surface; and
powering the at least one heating cable via the power source.

2. The method of claim 1, wherein each of the outer and inner insulating layers comprise a polyester batting sheet and a flexible foil sheet.

3. The method of claim 1, wherein the heating pad is disposed within a waterproof cover.

4. The method of claim 3, wherein the waterproof cover comprises a canvas material.

5. The method of claim 1, further comprising the step of providing a light electrically connected to the power source, wherein the light is turned on when power is supplied to the at least one heating cable.

6. The method of claim 1, wherein the at least one heating cable is two heating cables.

7. A beehive cover comprising:
at least one heating pad comprising:
an outer insulating layer;
an inner insulating layer;
at least one heating cable disposed in between the outer insulating sheet and the inner insulating sheet;
electric wiring connecting the at least one heating cable to a power source; and
a waterproof cover covering the at least one heating pad.

8. The beehive cover of claim 7, wherein each of the outer and inner insulating layers comprise a polyester batting sheet and a flexible foil sheet.

9. The beehive cover of claim 7, wherein the waterproof cover comprises a canvas material.

10. The beehive cover of claim 1, further comprising a light electrically connected to the power source, wherein the light is turned on when power is supplied to the at least one heating cable.

11. The beehive cover of claim 7, wherein the at least one heating pad comprises two heating cables.

12. The beehive cover of claim 7, further comprising a first insulating pad covering a first side of the beehive, a first heating pad covering a second side of the beehive, a second insulating pad covering a third side of the beehive, and a second heating pad covering a fourth side of the beehive.
